(19) United States
(12) Patent Application Publication
(10) Pub. No.: US 2026/0118217 A1
(43) Pub. Date: Apr. 30, 2026

(54) METHOD AND DEVICE FOR ORDER ANALYSIS

(71) Applicant: Klingelnberg AG, Zürich (CH)

(72) Inventor: Jan Merkert, Wipperfürth (DE)

(21) Appl. No.: 19/365,724

(22) Filed: Oct. 22, 2025

(30) Foreign Application Priority Data
Oct. 25, 2024 (DE) 10 2024 131 238.6

(51) Int. Cl. G01M 13/021; G01M 13/028

(52) U.S. Cl. CPC G01M 13/021; G01M 13/028

(57) ABSTRACT

A method including the following method steps of: performing a rolling test on a gear using a rolling test bench for single-flank rolling test and/or double-flank rolling test; generating an order spectrum from measurement data of the rolling test of the gear; and analyzing the order spectrum using a computer-implemented classification. The classification is designed to determine gearing deviations (I-X) of the gearing and test bench deviations (X1) of the rolling test bench. The method also includes the step of adjustment of a manufacturing process for the gearing based on determined gearing deviations (I-X) of the gearing and/or adjustment of the rolling test bench based on determined test bench deviations (XI, XII) of the rolling test bench.

### CROSS-REFERENCE TO RELATED APPLICATIONS

This application claims the benefit of German patent application 10 2024 131 238.6, filed on 25 Oct. 2024, the disclosure of which is incorporated herein by reference in its entirety.

### TECHNICAL FIELD

The present disclosure relates to a method and device for performing and analyzing a rolling test.

### BACKGROUND

In purely electric motor vehicle operation, the transmission noise is no longer masked by the noise of an internal combustion engine. The noise generated by the rolling gears can be perceived as disturbing by people inside the passenger compartment. In addition to the usual requirements for the efficiency and service life of a gearing, noise behavior therefore also plays a decisive role in assessing the quality of a gearing.

In addition to quality assurance using classic coordinate measuring technology, rolling test benches are therefore often used to assess the dynamic behavior of a gearing and, in particular, its noise behavior. The results of the rolling test also allow conclusions to be drawn about the quality of a large number of geometric parameters of the gearing, such as pitch, concentricity, and the like.

Rolling test results are often presented in an order spectrum. Dominant orders in the order spectrum can be used to draw conclusions about gearing deviations and also about the expected noise behavior in the fully assembled state of the gearing in question.

The analysis of such order spectra is carried out by a machine operator who derives changes for the manufacturing process based on empirical values from previous assessments. However, this procedure is highly dependent on the wealth of experience of the person concerned and is therefore prone to errors. Misjudgments regarding the geometric gearing deviations underlying the orders to be corrected can result in incorrect corrections to the manufacturing process. This can lead to a multitude of time-consuming and costly correction loops until an acceptable order spectrum is achieved.

Manual inspection and evaluation of order spectra can also lead to deviations in the test bench that can influence the order spectrum being interpreted as gearing deviations. For certain gearings, this can result in vibration excitation in the range of a natural frequency of the rolling test bench for the combination of tooth count and test speed, which is visible as a dominant order in the order spectrum. Similarly, wear on the drives, bearings, or mountings of the rolling test bench can cause dominant orders to be generated in the order spectrum that are not attributable to gearing deviations.

Such distortions of the order spectrum caused by the test bench itself are usually speed-dependent. Distortions in the order spectrum can therefore be detected if the order spectrum “migrates” above the speed, i.e., the dominant orders change with the speed. However, this requires that the person evaluating the order spectrum has detailed knowledge of these effects.

Order spectra are normalized with respect to speed. This means that the first order describes a measured amplitude that can be assigned to the test speed, with all other orders describing multiples of the test speed. Dominant orders that are purely attributable to deviations in the gear geometry are therefore the same for different speeds, i.e., the same orders are always recognizable as dominant orders, regardless of the test speed. In contrast, deviations resulting from deviations and, in particular, vibration excitations of the test bench itself are often speed-dependent, so that the order spectra change over the speed.

In order to assess whether the dominant orders recognizable in the order spectrum are due to geometric deviations in the gearing or result from an influence of the test bench on the measurement result, the person reviewing and assessing the respective order spectrum must have extensive experience. In practice, this can lead to several unsuccessful corrections being made to the manufacturing process for the gearing in question, even though the deviation to be corrected in the order spectrum results from the test bench itself and no adjustment to the manufacturing process is necessary.

Furthermore, even a very experienced person may be confronted for the first time with an order spectrum or error pattern that was previously unknown to them, e.g., when new or modified gear geometries are set up for series production for the first time, or when certain deviations or test bench deviations occur for the first time.

### SUMMARY

Against this background, the present disclosure is based on the technical problem of specifying a method that enables reliable analysis of an order spectrum from a rolling test. In particular, it should enable reliable correction and differentiation of gearing deviations and test bench deviations. Furthermore, a device for carrying out such a method should be specified.

The technical problem described above is solved in each case by the features of the independent claims. Further designs of the disclosure are apparent from the dependent claims and the following description.

According to a first aspect, the disclosure relates to a method comprising the following method steps of: performing a rolling test on a gearing using a rolling test bench for single-flank rolling testing and/or double-flank rolling testing; generating an order spectrum from measurement data of the rolling test of the gearing; analyzing the order spectrum using a computer-implemented classification, wherein the classification is designed to detect gearing deviations of the gearing and test bench deviations of the rolling test bench; adjustment of a manufacturing process for the gearing based on determined gearing deviations of the gearing and/or adjustment of the rolling test bench based on determined test bench deviations of the rolling test bench.

On the one hand, the computer-implemented classification makes it possible to detect gearing deviations of the gearing on the basis of the analyzed order spectrum. Furthermore, the classification makes it possible to distinguish gearing deviations from test bench deviations by detecting test bench deviations.

This prevents incorrect corrections being made to the manufacturing process, even though the cause of the deviations detected in the order spectrum is actually due to test bench deviations. In other words, it prevents the incorrect assignment of dominant orders to gearing deviations that do not actually exist, the correction of which would not improve the order spectrum for subsequent measurements.

Computer-implemented classification also makes it possible to provide a broad database whose scope exceeds the knowledge of most users regarding the interpretation of order spectra. This means that even rare order spectrum curves can be reliably evaluated and corrected in a targeted manner. In particular, the ability to use computers to distinguish between gearing deviations and test bench deviations can avoid lengthy trial-and-error approaches in operational practice.

If the analysis of the order spectrum reveals that the gearing deviates from its target geometry and requires correction, the manufacturing process can be adjusted using computer-implemented methods. This means, for example, that the kinematics of a gear cutting process, such as a grinding process, is adjusted and/or the geometry of a tool used for gear cutting, such as a grinding tool, is adjusted in order to reduce the deviations of the gearing from its target geometry or to improve the noise behavior of the gearing. The correction parameters required for this to adjust the kinematics and/or the tool geometry can be generated automatically using software.

A closed control loop for quality assurance can thus be specified, wherein impermissible amplitudes of dominant order in an order spectrum are corrected by adjusting the manufacturing process in order to reduce these amplitudes to a permissible level.

The above procedure can also be automated for test bench deviations, wherein, for example, maintenance requirements for certain components of the rolling test bench can be indicated, alternative test speeds can be suggested, or, for example, the damping or stiffening of certain components of the rolling test bench can be suggested.

The term “adjustment” of the test bench is to be interpreted broadly in this context and includes any influence on the rolling test bench that leads to a reduction or elimination of the influence of the rolling test bench on the measurement result. This may involve, for example, the replacement, repair, or maintenance of components of the rolling test bench, or adjustments may be made to the test sequence, such as the test speed or test speed curves, a contact force in the tooth contact, or the like.

The terms “test bench” and “rolling test bench” are used synonymously in this text.

When reference is made in this case to single-flank rolling tests, this relates to the well-known test method for testing toothed gearings. In this test, the gearing to be tested rolls with a fixed center distance with an assigned mating gear or a master gear. The single-flank rolling test can be used to detect the following gearing deviations, for example: concentricity, rolling deviation, concentricity error, tooth-to-tooth amplitude, maximum rolling deviation, transmission error and dynamic backlash, noise behavior, surface defects.

When reference is made in this case to double-flank rolling tests, this relates to the well-known test method for testing toothed gearings. In this test, the gearing to be tested rolls with a non-constant center distance with an assigned mating gear or a master gear, wherein a defined contact force is set between the rolling gearings. The two-flank rolling test can be used to detect the following gearing deviations, for example: concentricity, tooth-to-tooth runout, rolling deviation, double ball dimension, noise behavior.

The methods of rolling test with rotational error analysis, or in particular single-flank rolling test and double-flank rolling test, are included in the prior art and well known. The core of the disclosure is not the rolling test or the single-flank rolling test or the double-flank rolling test itself, but rather the computer-implemented detection and differentiation of gearing deviations and test bench deviations in order spectra that represent the results of such rolling tests.

First, an order analysis can generate the results of the rolling test as an order spectrum. Individual orders and/or order ranges of the order spectrum can be assigned test characteristics of the gearing, such as concentricity errors, wobble, pitch errors of the first order and/or higher orders, surface waviness, flank shape errors, or the like. The results of the rolling test are generated in particular by providing the rotation-related axis data of the rolling test bench as an order spectrum, e.g., using FFT. The abbreviation FFT stands for fast fourier transformation.

The orders are multiples of the speed of the gearing on the rolling test bench, so that measured deviations or measured values are plotted as amplitudes over the individual orders.

The gearing to be tested is a toothed gearing for power transmission with speed and torque conversion. The method according to the disclosure can be applied equally to both spur gears and bevel gears, for example.

It may be provided that the classification is performed using an AI model, such as a neural network or the like, which has been trained using training data.

According to one design of the method, it may be provided that the training data relating to a plurality of classification classes indicating gearing deviations comprises, for each of these classes, at least one amplitude of an order and/or at least one progression of an order spectrum that are characteristic of one gearing deviation or several gearing deviations, wherein these classes differ from one another with respect to at least one associated gearing deviation.

It may be provided that the training data relating to at least one class of the classification indicating test bench deviations comprises at least one amplitude of an order and/or at least one progression of an order spectrum that are characteristic of one test bench deviation or several test bench deviations.

Alternatively or additionally, it may be provided that the training data relating to at least one class of the classification indicating test bench deviations comprises at least one amplitude of an order and/or at least one progression of an order spectrum that is non-characteristic of one gearing deviation or several gearing deviations.

It may be provided that the AI model has been trained using training data that enables classification of the gearing deviations optimized with regard to the noise behavior of the gearing, in particular the psychoacoustics.

Alternatively or in addition, it may be provided that the AI model has been trained using training data that enables classification of the gearing deviations optimized with regard to the service life of the gearing.

Alternatively or additionally, it may be provided that the AI model has been trained using training data that enables classification of the gearing deviations optimized with regard to the efficiency of the gearing.

According to one design of the method, it may be provided that several AI models are provided, wherein the AI models have been trained using training data that enables classification of the gearing deviations optimized with regard to one or more of the following aspects: noise behavior of the gearing, in particular psychoacoustics; service life of the gearing; efficiency of the gearing.

It may be provided that, after the adjustment of the gearing manufacturing process and/or the adjustment, in particular maintenance, of the test bench, the rolling test and the analysis are performed again for the same or another identical gearing in order to identify the effectiveness or ineffectiveness of the adjustment and/or maintenance, wherein data on the effectiveness or ineffectiveness of the adjustment and/or maintenance are used as further training data for the AI model in order to improve the AI model.

According to one design of the method, training data, AI models, and adjustments that are to be assigned to identical rolling test benches may be collected and stored on a server.

It may be provided that, based on a result of the analysis, predefined recommendations for action or predefined assessments are issued to an operator, in particular in text form.

It may be provided that an AI-based dialogue takes place with the operator, in which the effectiveness or ineffectiveness of the recommended measures is queried.

If they are ineffective, further recommendations for action can be generated based on AI. If the recommendations for action are ineffective, assigned measurement data from the non-improved gearing can serve as input data for improving the AI model.

If the recommended actions are effective, the associated measurement data for the improved gearing can be used as input data to improve the AI model.

According to a second aspect, the disclosure relates to a device for rolling testing of gearings, wherein the device is designed to perform the following method steps of: performing a rolling test of a gearing using a single-flank rolling test and/or double-flank rolling test; generating an order spectrum from measurement data of the rolling test of the gearing; analyzing the order spectrum by means of a computer-implemented classification, wherein the classification is designed to determine gearing deviations of the gearing and test bench deviations of the rolling test bench.

### BRIEF DESCRIPTION OF THE DRAWINGS

The disclosure is explained in more detail below with reference to a drawing illustrating an exemplary embodiment. The following figures show schematically:

FIG. 1 shows method steps of a method according to the disclosure;

FIG. 2A shows an order spectrum for a first rotational speed;

FIG. 2B shows an order spectrum for a second rotational speed; and

FIG. 2C shows an order spectrum for a third rotational speed.

### DETAILED DESCRIPTION OF THE DRAWINGS

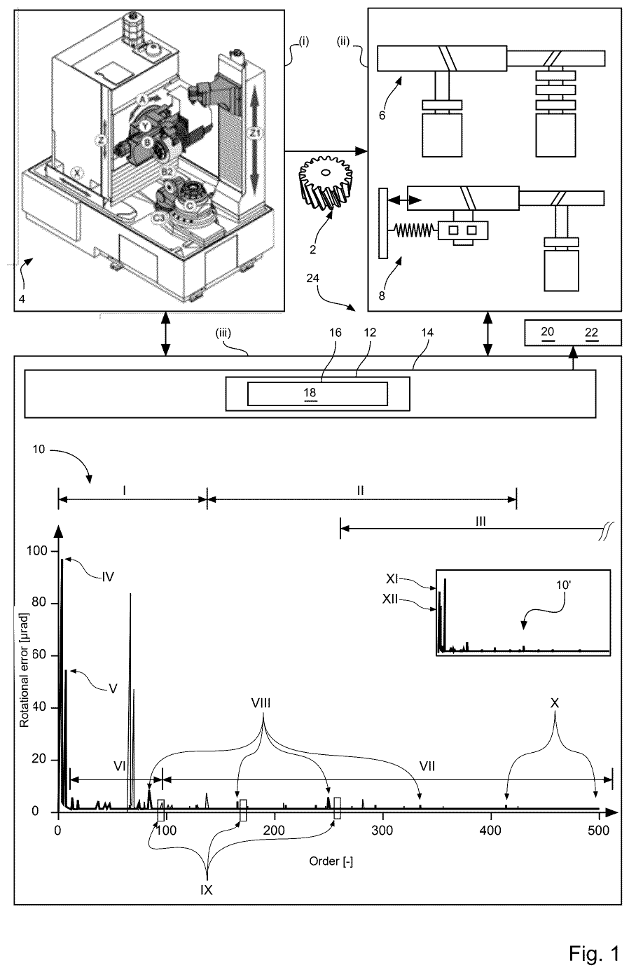

FIG. 1 shows the method steps of a method according to the disclosure. First, a gearing 2 is machined by means of a gear cutting machine 4 in a first method step (i).

The gear cutting machine 4 can be, for example, a gear grinding machine.

After machining, the gearing 2 is subjected to a rolling test in a method step (ii), specifically, a single-flank rolling test and/or a double-flank rolling test. For this purpose, a test bench 6 for single-flank rolling tests and a test bench 8 for double-flank rolling tests are shown schematically as examples. Test benches are known that are suitable for both single-flank rolling tests and double-flank rolling tests.

In a method step (iii), an order spectrum 10 is generated from the measurement data of the rolling test of the gearing 2. Furthermore, in method step (iii), an analysis of the order spectrum 10 is performed by means of a computer-implemented classification 12, wherein the classification 12 is designed to determine gearing deviations I-X of the gearing 4 and test bench deviations XI, XII of the rolling test bench 6, 8.

According to method step (iii), a measured rotational error in urad is plotted over the orders, resulting in the order spectrum 10. The deviations determined by means of the rolling test are thus provided as an order spectrum.

Using computer-implemented classification 12, individual orders or order ranges of the order spectrum 10 are assigned to tooth profile deviations of gearing 2.

Anomalies in the rolling test that occur in order range I are attributable, for example, to pitch errors in gearing 2. Order range I extends, for example, from the first order to approximately the 160th order.

Anomalies in the rolling test that occur in an order range II are, for example, attributable to deviations in a profile or a flank of the gearing 2. The order range II extends, for example, from approximately the 160th order to the 430th order.

Anomalies in the rolling test that occur in order range III are, for example, attributable to waviness of the tooth flanks of gearing 2. Order range III extends, for example, from the 290th order to beyond the 500th order.

The values given for the extent of the order ranges are only examples to illustrate the procedure according to the disclosure.

In addition to the aforementioned order ranges I, II, and III, individual orders can also be assigned to specific gearing deviations of gearing 2.

For example, the first order of the order spectrum according to the rolling test describes the concentricity error of a gearing, wherein the assigned rotational error of the first order has been designated IV here. The second order of the order spectrum according to the rolling test corresponds to the wobble of the gearing, wherein the assigned rotational error of the second order has been designated V here.

An order range designated VI extends from the third order of the rolling test to the first tooth engagement order, with dominant orders within this order range indicating periodically occurring pitch errors.

An order range designated VII is assigned to those orders of the rolling test that cannot be assigned to any engagement frequencies or their harmonics or harmonic sidebands, wherein these orders can also be collectively referred to as ghost orders.

The individual tooth engagement orders according to the first, second, third, and fourth tooth engagement orders are designated VIII in the present case.

IX denotes ranges that affect the sidebands of the harmonic meshing frequencies, which are modulated by the periodic pitch deviation.

Tooth engagement orders according to the fifth tooth engagement order or higher are designated with X and are usually attributable to waviness of the surface of the flanks.

Test bench deviations XI and XII are assigned, for example and schematically, an order spectrum 10′ which has been determined for a speed different from the order spectrum 10 and whose dominant orders differ from those of the order spectrum 10.

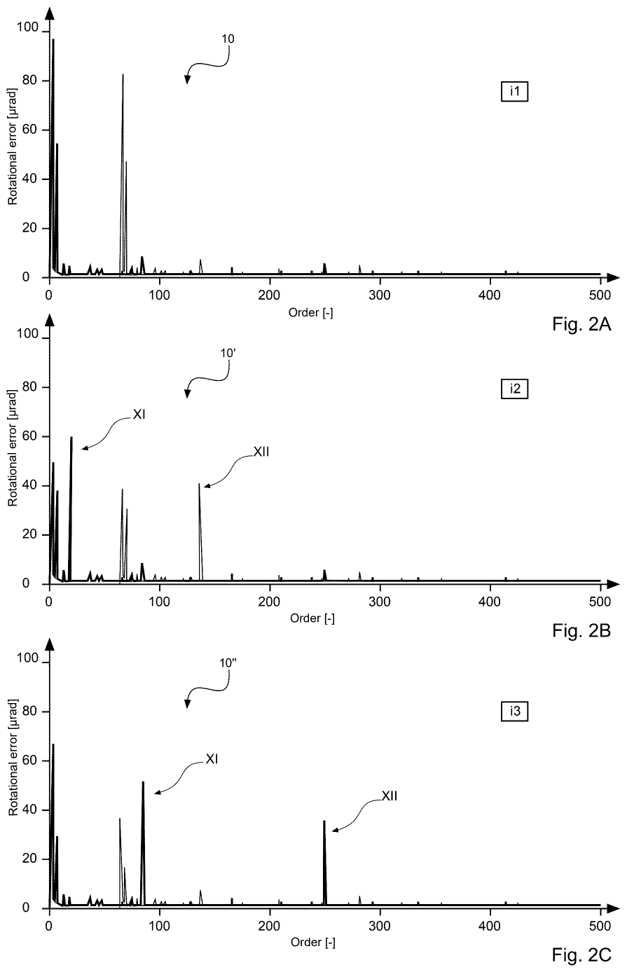

This is illustrated in FIGS. 2A, 2B, and 2C. FIG. 2A shows the order spectrum 10 determined for a test speed i1. FIG. 2B shows the order spectrum 10′ determined for a test speed i2 that differs from the test speed i1. FIG. 2C shows an order spectrum 10″ determined for a test speed i3 that differs from the test speeds i1 and i2. It therefore applies that i1≠i2≠i3.

As shown in FIGS. 2A, 2B, and 2C, the dominant orders differ for the different speeds i1, i2, and i3. In other words, the dominant orders “migrate” with the speed. This is an indication that test bench deviations XI and/or XII are distorting the measurement result of the rolling test. An operator could therefore be instructed to first correct test bench deviations XI and/or XII, e.g., by maintaining or repairing bearings, mountings, or drives on the test bench, before gearing deviations can be meaningfully detected and evaluated.

The designation of the test bench deviations with XI and XII is to be understood as an example. Furthermore, test bench deviations that are not speed-dependent can also be detected and taken into account.

In the method step (iii) according to FIG. 1, the manufacturing process for gearing 2 is therefore adjusted on the basis of the detected gearing deviations I-X of gearing 2 and/or the rolling test bench 6, 8 is adjusted on the basis of the detected test bench deviations XI, XII of the rolling test bench 6, 8, or a proposal is issued for adjusting the manufacturing process for gearing 2 based on detected gearing deviations I-X of gearing 2 and/or a proposal for adjusting the rolling test bench 6, 8 based on detected test bench deviations XI, XII of the rolling test bench 6, 8.

The computer-implemented classification 12 and the adjustment of the manufacturing process and/or the adjustment of the rolling test bench 6, 8 can be carried out by means of a control and evaluation unit 14.

The classification is performed by means of an AI model 16, namely a neural network that has been trained using training data 18.

It is provided that the training data 18 relating to a plurality of classification classes indicating gearing deviations I-X comprises, for each of these classes, at least one amplitude of an order and/or at least one progression of an order spectrum that is characteristic of a gearing deviation I-X or of several gearing deviations I-X, wherein these classes differ from one another with respect to at least one assigned gearing deviation I-X.

It is further provided that the training data 18 relating to at least one class of the classification indicating test bench deviations XI, XII comprises at least one amplitude of an order and/or at least one progression of an order spectrum which are characteristic of a test bench deviation XI, XII or for several test bench deviations XI, XII and/or the training data relating to at least one class of the classification indicating test bench deviations XI, XII comprises at least one amplitude of an order and/or at least one progression of an order spectrum which are not characteristic of a gearing deviation I-X or for several gearing deviations I-X.

After the adjustment of the manufacturing process of the gearing 2 and/or, for example, maintenance of the test bench 6, 8 and/or an adjustment of the rolling test, the rolling test and the analysis are performed again for the same or another similar gearing to identify the effectiveness or ineffectiveness of the adjustment and/or maintenance, wherein data on the effectiveness or ineffectiveness of the adjustment and/or maintenance is used as further training data for the AI model 16 in order to improve the AI model 16.

Based on a result of the analysis, predefined recommendations for action 20 and/or predefined assessments 22 are issued to an operator, in particular in text form.

FIG. 1 therefore shows a device 24 for rolling testing of gearings, wherein the device 24 is set up to perform the following method steps: Performing a rolling test of the gearing 2 by means of single-flank rolling test and/or double-flank rolling test; generating the order spectrum 10 from measurement data of the rolling test of the gearing 2; analyzing the order spectrum by means of a computer-implemented classification 12, 10 wherein the classification is designed to detect gearing deviations I-X of the gearing 2 and test bench deviations XI, XII of the rolling test bench 6, 8.

1. A method including the steps of:
performing a rolling test on a gearing using a rolling test bench for single-flank rolling testing and/or double-flank rolling testing;
generating an order spectrum from measurement data of the rolling test of the gearing;
whereby
analyzing the order spectrum using a computer-implemented classification, wherein the classification is designed to determine gearing deviations of the gearing and test bench deviations of the rolling test bench; and
adjustment of a manufacturing process for the gearing based on determined gearing deviations of the gearing and/or adjustment of the rolling test bench based on determined test bench deviations of the rolling test bench.

2. The method according to claim 1,
wherein the classification is performed using an AI model, such as a neural network or the like, which has been trained using training data.

3. The method according to claim 2,
wherein the training data relating to a plurality of classification classes indicating gearing deviations comprise, for each of these classes, at least one amplitude of an order and/or at least one progression of an order spectrum that are characteristic of one gearing deviation or several gearing deviations, wherein these classes differ from one another with respect to at least one associated gearing deviation.

4. The method according to claim 2,
wherein the training data relating to at least one class of the classification indicating test bench deviations comprises at least one amplitude of an order and/or at least one progression of an order spectrum that are characteristic of one test bench deviation or several test bench deviations
and/or
the training data relating to at least one class of the classification indicating test bench deviations comprises at least one amplitude of an order and/or at least one progression of an order spectrum that are non-characteristic of one gearing deviation or several gearing deviations.

5. The method according to claim 2,
wherein the AI model has been trained using training data that enables classification of the gearing deviations optimized with regard to the noise behavior of the gearing,
and/or
the AI model has been trained using training data that enables classification of the gearing deviations to be optimized with regard to the service life of the gearing,
and/or
the AI model has been trained using training data that enables classification of the gearing deviations optimized with regard to the efficiency of the gearing.

6. The method according to claim 2,
wherein several AI models are provided, wherein the AI models have been trained using training data that enables classification of the gearing deviations optimized with regard to one or more of the following aspects:
noise behavior of the gearing;
service life of the gearing; and
efficiency of the gearing.

7. The method according to claim 2,
wherein after the adjustment of the manufacturing process of the gearing and/or maintenance of the test bench, the rolling test and analysis are performed again for the same or another identical gearing in order to identify the effectiveness or ineffectiveness of the adaptation and/or maintenance, wherein data on the effectiveness or ineffectiveness of the adaptation and/or maintenance are used as further training data for the AI model in order to improve the AI model.

8. The method according to claim 2,
wherein training data, AI models, and adjustments that are to be assigned to structurally identical rolling test benches are collected and stored on a server.

9. The method according to claim 1,
wherein based on a result of the analysis, predefined recommendations for action or predefined assessments are issued to an operator.

10. A device for rolling testing of gearings, wherein the device is designed to perform the following method steps: performing a rolling test of a gearing using a single-flank rolling test and/or double-flank rolling test; generating an order spectrum from measurement data of the rolling test of the gearing; analyzing the order spectrum by means of a computer-implemented classification, wherein the classification is designed to determine gearing deviations of the gearing and test bench deviations of the rolling test bench.
